(19) United States
(12) Patent Application Publication
(10) Pub. No.: US 2015/0328966 A1
(43) Pub. Date: Nov. 19, 2015

(54) EXTRUDED VISOR FOR OPEN-ROOF VEHICLES

(71) Applicant: Marcus Automotive, LLC, Holland, MI (US)

(72) Inventors: Konrad H. Marcus, Holland, MI (US); William J. Fluharty, Holland, MI (US)

(73) Assignee: Marcus Automotive, LLC

(21) Appl. No.: 14/716,018

(22) Filed: May 19, 2015

Related U.S. Application Data
(60) Provisional application No. 62/000,223, filed on May 19, 2014.

(51) Int. Cl. B60J 3/02

(52) U.S. Cl. CPC B60J 3/026; B60J 3/0208; B60J 3/0265; B60J 3/0282

(57) ABSTRACT

A visor has a curvilinear extruded panel with end caps and is pivotally mounted to the header rail of a vehicle and, when in a stored position, conforms closely to the geometry of the header rail. It is mounted to allow the visor to pivot away from the windshield toward the driver or passenger, lowering the visor to provide sun-blocking protection. The curvilinear visor body may also include a glare shield which can be extended from the lower edge of the visor to provide additional sun-blocking protection.

### CROSS-REFERENCE TO RELATED APPLICATIONS

This application claims priority under 35 U.S.C. §119(e) and the benefit of U.S. Provisional Application No. 62/000,223 entitled EXTRUDED VISOR FOR OPEN-ROOF VEHICLES, filed on May 19, 2014, by Konrad H. Marcus and William J. Fluharty, the entire disclosure of which is incorporated herein by reference.

### BACKGROUND OF THE INVENTION

The present invention relates to visors and particularly a visor which can be mounted to the header rail of an open-roof vehicle.

A recent trend in sport vehicles, such as the Jeep® Wrangler® JK, and others is to provide removable tops to provide an open, convertible-like feel for the occupants. To date, such vehicles have employed conventional visors mounted to the header rail extending between the A-pillars of the vehicle. Such vehicles do not have conventional headliners with pockets allowing conventional visors to nest therein. As a result, conventional visors, when mounted to such a vehicle, appear somewhat ungainly when in a raised stowed position with the top removed and need to be moved when the top is being installed or removed since the roof latching mechanism must clear the visor area. One solution is disclosed in U.S. Pat. No. 8,657,357, the disclosure of which is incorporated herein by reference.

### SUMMARY OF THE INVENTION

The present invention improves upon existing visors employed in vehicles with detachable roofs by integrating an extruded curved panel visor which attaches to a header rail of the vehicle in a manner in which the visor panel follows the curve of the windshield header rail, providing a smooth clean appearance for the visor installation. The visor is hinged at the top and can be lowered from a nested stowed position in a direction rearwardly away from the windshield to a use position In a preferred embodiment of the invention, the visor body is an extruded ribbed and curved panel to which reinforcing end caps are attached. One or more pivot rods are positioned in the end caps and are secured to the windshield header by pivot rod mounting torque clips. The visor may include a secondary glare shield which rotates from a nested position with the curved visor panel to an extended position to provide additional sun-blocking protection for the visor. In some embodiments, additional features, such as a vanity mirror, can be provided. In a most preferred embodiment, the visor is integrated into a two or three visor system which extends across the header rail and forms a unitary structure which provides a smooth clean appearance to the area above the windshield and functional sun-blocking protection with the roof in place or the roof removed.

These and other features, objects and advantages of the present invention will become apparent upon reading the following description thereof together with reference to the accompanying drawings.

### BRIEF DESCRIPTION OF THE DRAWINGS

FIG. 1 is a perspective view of a vehicle embodying the visor system of the present invention, shown with the visors in a stowed position;

FIGS. 2 and 2A are perspective views of the visor system shown in FIG. 1, shown removed from the vehicle with the visors in a fully rotated stowed position;

FIGS. 3 and 3A are perspective views of the visor system shown in FIGS. 2 and 2A from the opposite side;

FIGS. 4 and 4A are perspective views of the visor system shown in FIGS. 2 and 2A with the center visor in a stowed position;

FIGS. 5 and 5A are perspective views of the visor system with the driver side visor only deployed;

FIGS. 6 and 6A are perspective views of the visor system with only the driver side visor and auxiliary glare shield deployed;

FIGS. 7 and 7A are upper perspective views of the structure shown in FIGS. 6 and 6A;

FIGS. 8 and 8A are rear perspective views of the visor system as seen in FIGS. 3 and 3A shown with the passenger side glare shield deployed;

FIGS. 9 and 9A are enlarged fragmentary top perspective views of the right side of the driver's visor shown in a stowed position;

FIGS. 10 and 10A are fragmentary enlarged perspective views of the right-side mount of the visor shown in FIGS. 9 and 9A with the visor fully deployed and the glare shield lowered and also showing the link arm pivot mechanism;

FIGS. 11 and 11A are rear perspective left side views of the driver's side visor shown fully deployed and with the glare shield also deployed;

FIGS. 12 and 12A are rear elevational views of the visor shown in FIGS. 11 and 11A also showing the torque devices;

FIGS. 13 and 13A are exploded top perspective views of the driver's side visor oriented in a stowed position;

FIGS. 14 and 14A are exploded top perspective views of the passenger side visor; and

FIGS. 15 and 15A are exploded top perspective views of the center visor.

### DETAILED DESCRIPTION OF THE PREFERRED EMBODIMENT

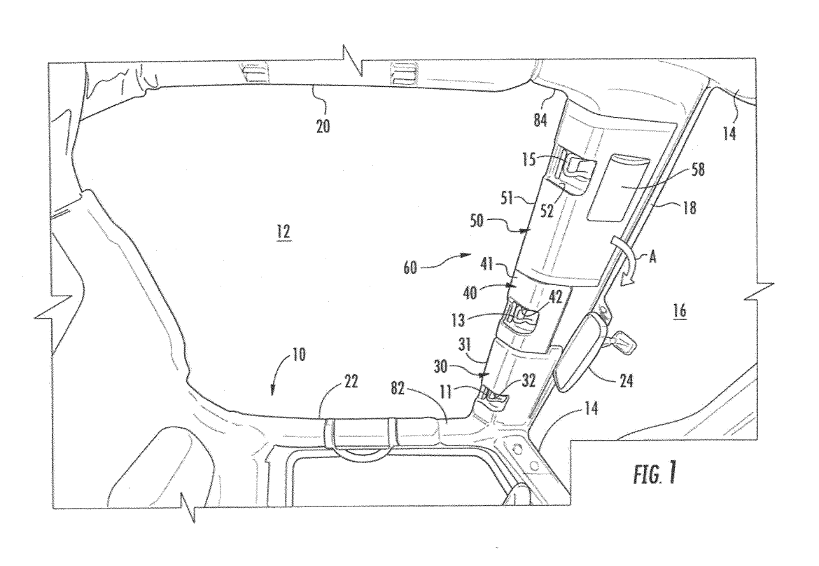

Referring initially to FIG. 1 there is shown a vehicle 10 with an open roof 12 formed by the removal of a roof panel (not shown). The vehicle may be one of several models, including, as an example only, a Jeep® Wrangler® JK made by Chrysler Corporation. The vehicle includes a pair of A-pillars 14 on either side of the windshield 16, a windshield header rail 18 extending between the A-pillars, and side support bars 20, 22 extending rearwardly and joined to a rear cross support structure (not shown). The vehicle includes a rearview mirror assembly 24 mounted to the windshield in the typical center area, as seen in FIG. 1.

The improved visor of the present invention may include a single visor, a pair of visors, or a three visors in an overall system, as shown in the Figs. The visor system 60, shown in FIG. 1 includes three visors 30, 40, and 50, corresponding to the driver's side visor, a center visor, and a passenger's side visor. Each of the visors are hinged along their top edges 31, 41, and 51 to pivot downwardly and away from the windshield from the stowed position, shown in FIG. 1 in a direction indicated by arrow A in FIG. 1, to a typical use position as shown in FIGS. 4 and 4A and FIGS. 5 and 5A. The visors are mounted on pivot rods, as described below.

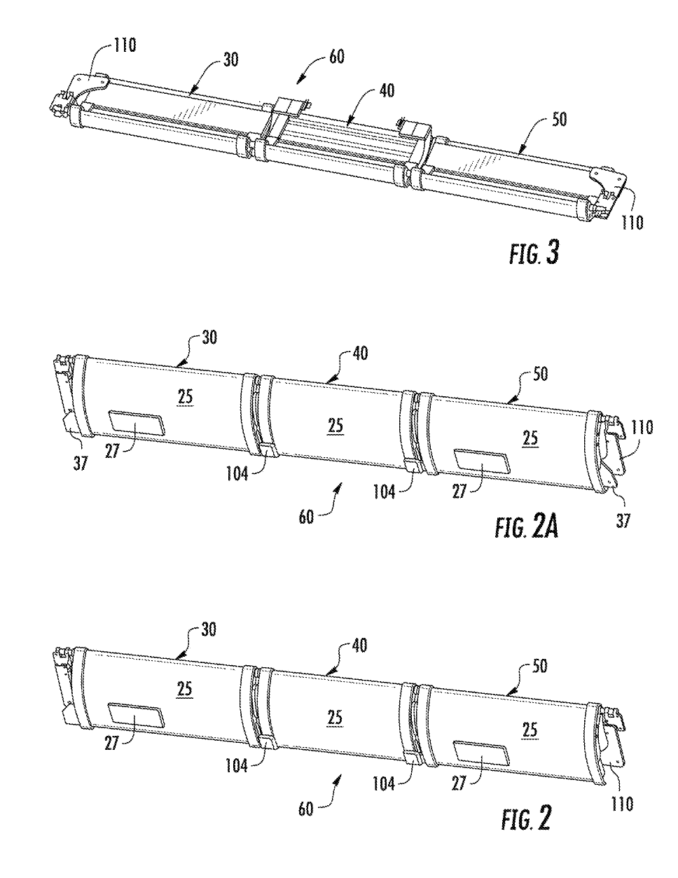

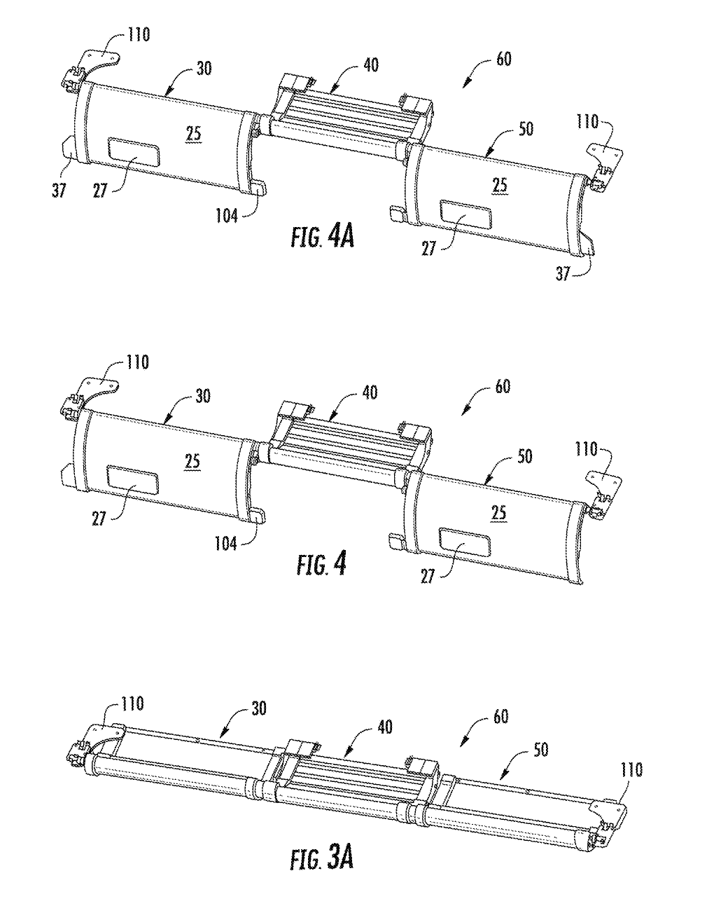

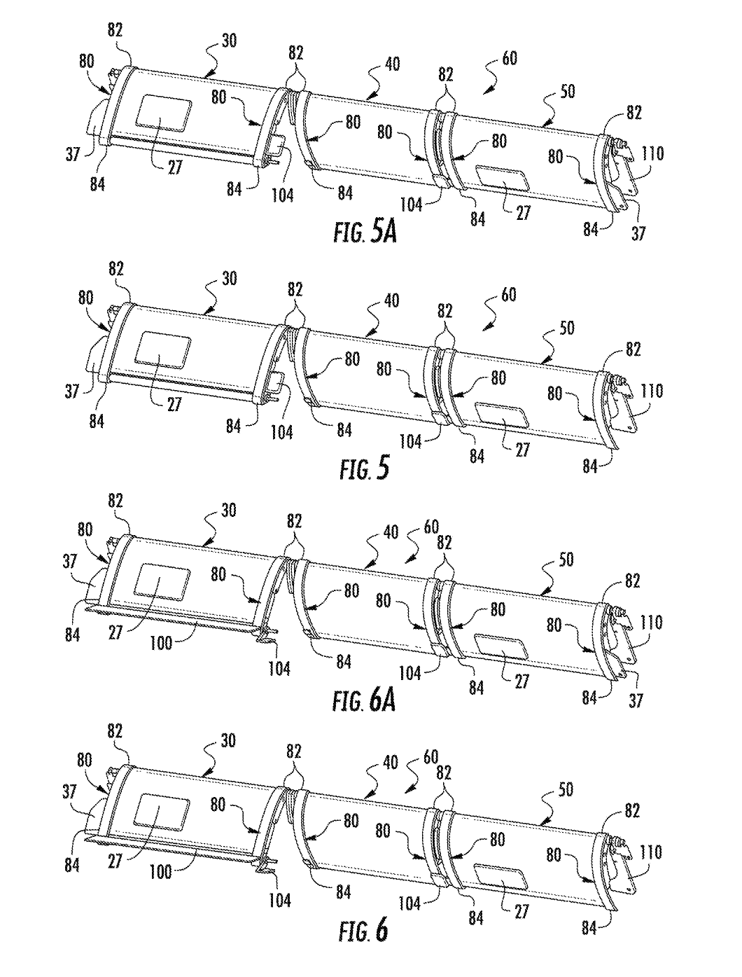

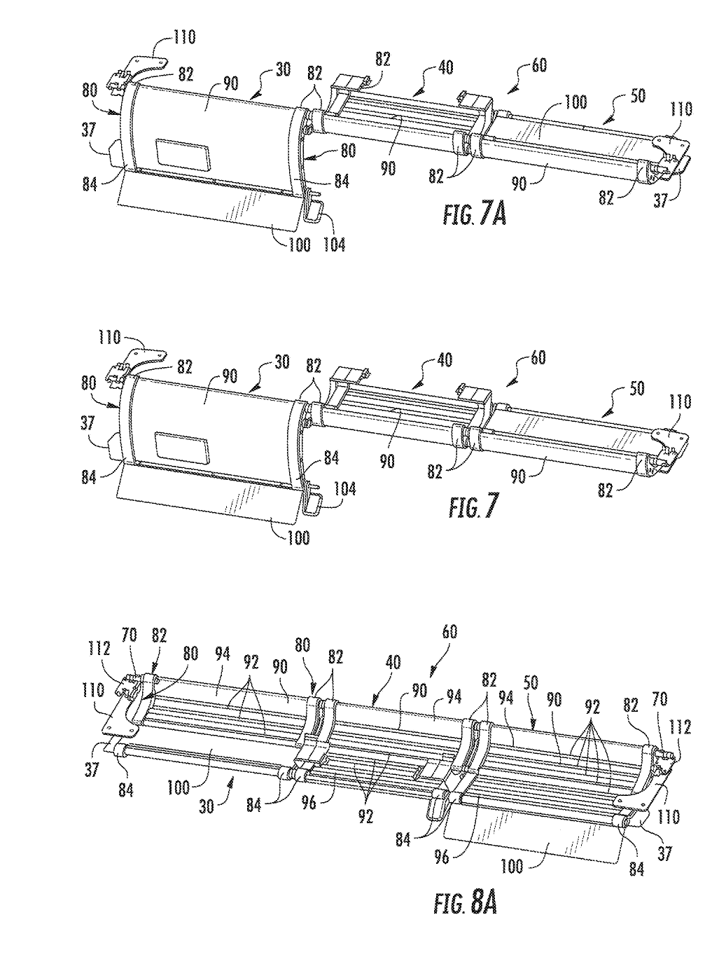

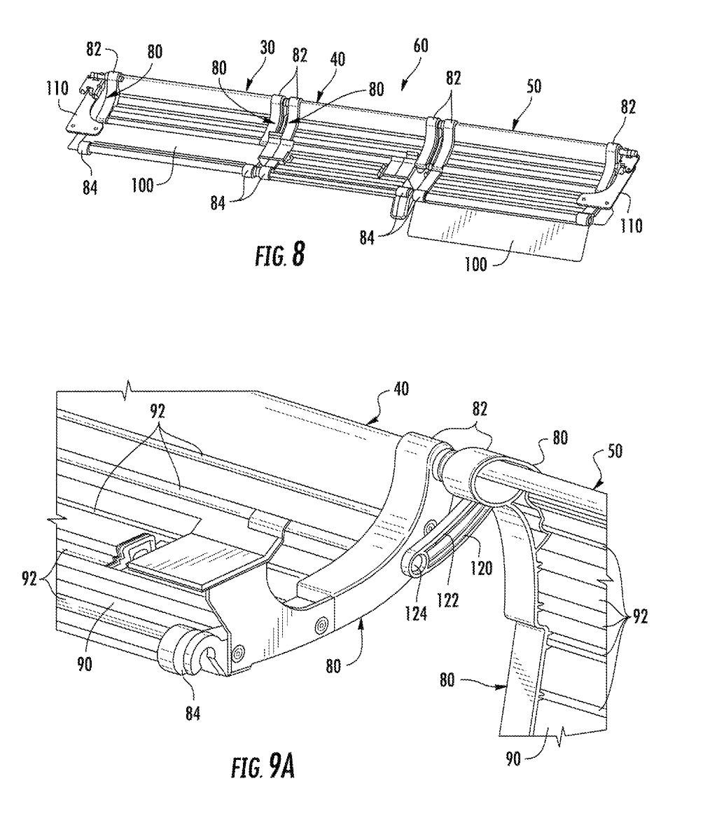

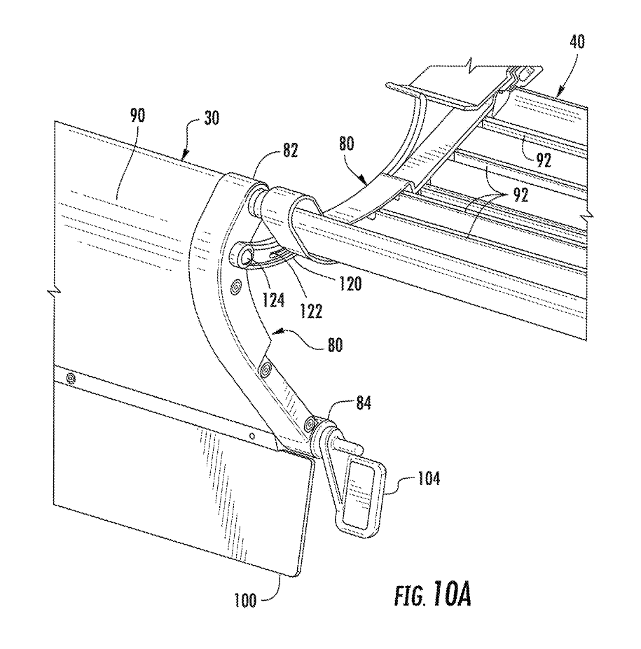

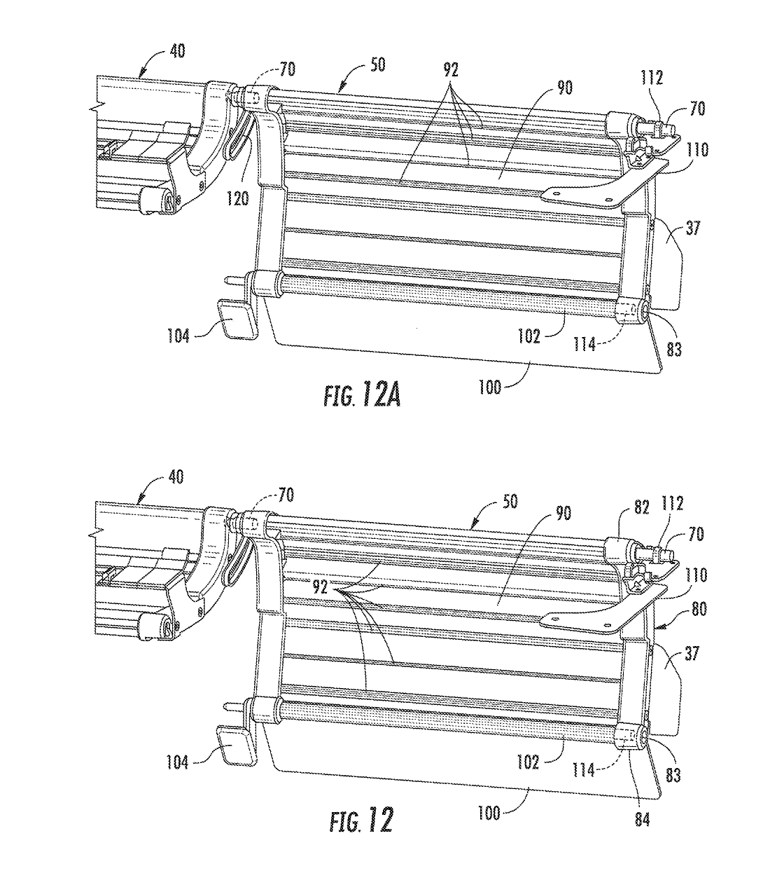

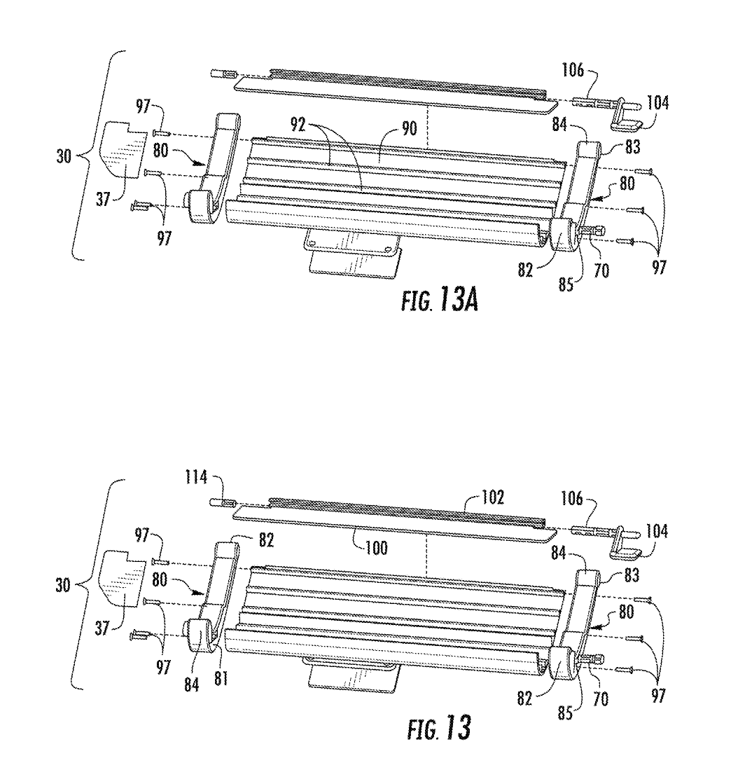

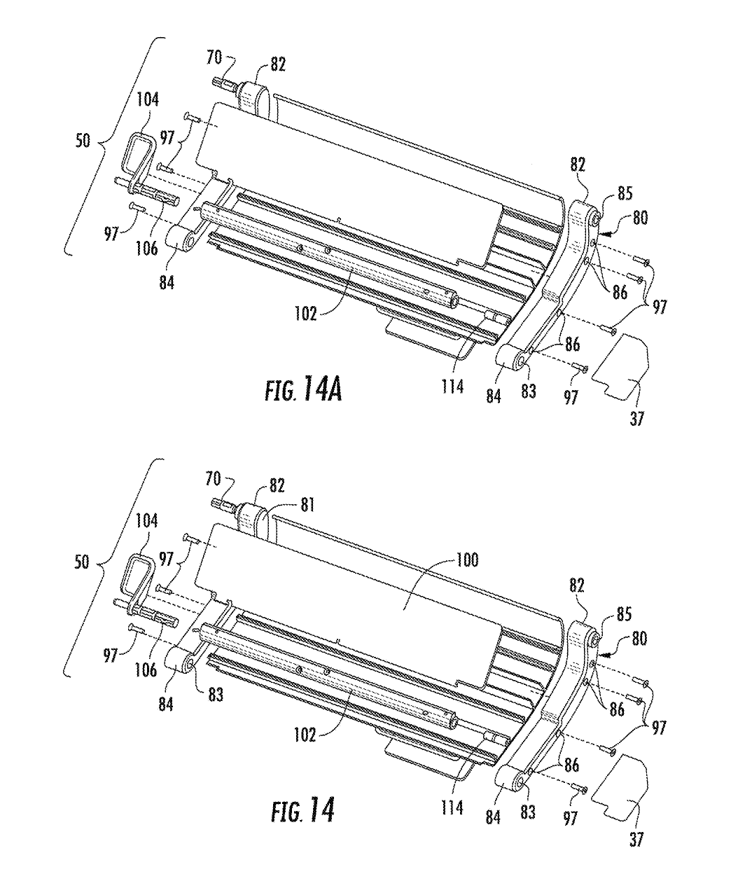

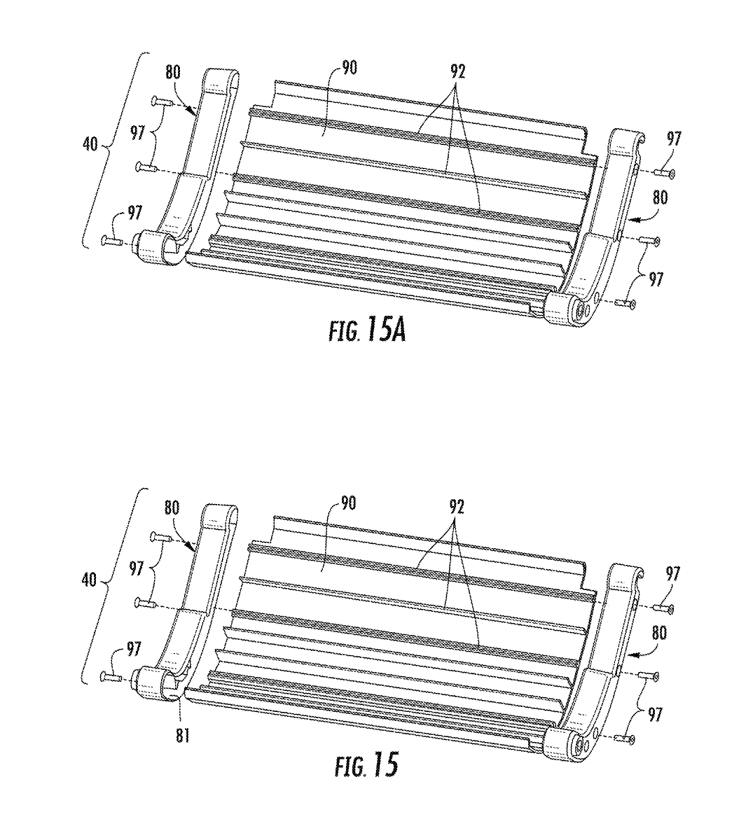

Visor system 60 can be a one-piece assembly, as shown in FIGS. 2A-8A, which are interconnected by pivot pins 70 (see FIGS. 8, 11, and 12), which extend from the upper edge of each of the curved end caps 80 of visor panels 90 forming the body of the visors 30, 40, and 50 and interconnect adjacent end caps 80 or secure the outer end caps to mounting brackets 110. Panels 90 are extruded from a polymeric material such as PVC, ABS, or other polymeric material suitable for the automotive environment. Each of the extruded visor panels 90 include longitudinally spaced parallel ribs 92 providing rigidity to the visor panels, which are further reinforced by end caps 80 having an upper end 82 and a lower end 84 on each of the ends of the visors. The end caps include curved slots 81 (FIGS. 13-15) for receiving the opposite edges of panels 90 and are secured to the panels by fasteners 97, which extend through apertures 86 (FIG. 14) in end caps 80 into an associated and aligned hollow extruded reinforcing rib 92 of the panels 90. The lower edge of the visors 30 and visor panels 90 and the opposite end caps 82, 84 are curved to conform to the visor panels 90 which, in turn, conform to the header rail 18 of the installation, as illustrated in FIG. 1. For such purpose, each of the visor panels 90 include an upper curved section 94 and a lower relatively straight section 96 (FIG. 8). Ends 82 and 84 of end caps 80 are somewhat enlarged to receive and support the pivot pins 70, as well as a pivot rod 102 (FIG. 11) extending along an auxiliary glare shield 100 (FIGS. 11 and 12). Pivot rod 102 is controlled by a lever 104 coupled to the pivot rod 102 to allow the auxiliary glare shield 100 to pivot from a nested position, as shown by visor 30 in FIG. 8, to a deployed position, as shown in the passenger side visor 50, also in FIG. 8. The visor assembly 60 are attached to the vehicle roof utilizing a pair of mounting brackets 110, as seen in FIGS. 7 and 8, which include torque clip 112 at an end which surrounds the pivot pins 70, as best seen in FIG. 11, to provide torque for the pivot rod 102 extending from the end 82 of end caps 80 of the visor system.

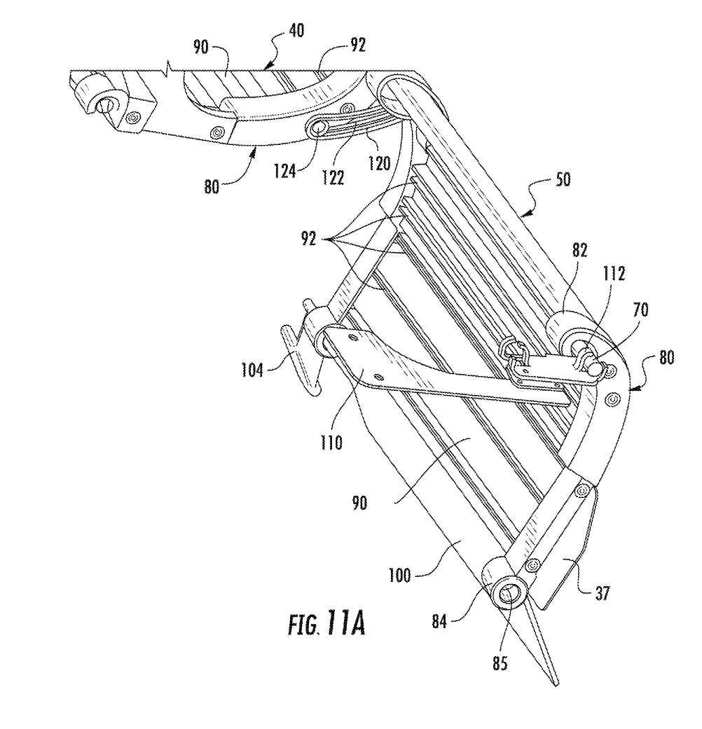

As seen in FIGS. 9-11, the extent to which the visors 30 and 50 can be deployed from a stored position shown in FIG. 2 to a fully deployed position, as shown in FIGS. 5 and 8, is controlled by an arcuate slotted arm 120 having a slot 122 therein, which is slideably and captively held to the end cap 80 by a fastener 124 and is secured at its upper end 82 of an adjacent end cap 80 in fixed relationship. Thus, the visor panel 90 can only move through an arc of about 30° to about 45° depending on the vehicle, which movement is controlled by the slot 122 of the arcuate arm 120. This constrains the movement of the visor from a fully stored position to a fully deployed position for maximum sun blocking protection of the main visors 30, 40, and 50, as well as positions the auxiliary glare shield typically mounted to the lower edges of the visor to a position for maximum sun-blocking protection.

Auxiliary glare shield 100 is attached to a pivot rod 102, as best seen in FIGS. 12-14, which pivot rod includes a torque fitting 114 that fits within an aperture 85 and ends 84 of the end cap 80. The control levers 104 for visors 30 and 50 include a rod 106 that rotatably extends through aperture 83 (FIG. 13) in lower end 84 of end caps 80 and is fixedly attached within and rotates the glare shield to any operator selected position. Likewise end 82 of end caps 80 include apertures 85 (FIGS. 14 and 15) for receiving the pivot pins 70 (FIG. 12) which can be bonded to the end caps 80 by ultrasonic welding thereto or otherwise fixedly secured to the end caps 80 and positioned within the torque clips 112 to provide the desired holding and moving forces for the visors of this visor system.

Each of the visors 30, 40, and 50 are integrally extruded panels 90 having a substantially flat lower section 96 (FIG. 8) and a curved upper section 94. The curved panels, thus, are shaped to conform to the header rail to provide a smooth continuous line across the top of the windshield, as seen in FIG. 1. The top ends 82 of each of the end caps 80 include an insert-molded pivot pin 70, as best shown in the exploded views of FIGS. 13 and 14 and in the assembled view of FIGS. 8 and 11. The visor panels 90 making up visors 30, 40, and 50 are extruded of a suitable polymeric material, such as PVC, ABS, or other polymeric material which is suitable for use in automotive applications. The visor pins 70 and corresponding rods for the center visor 40 (not shown) are fixed with respect to the visor panels and rotate with respect to each adjacent visor and the header assembly 18, as shown in FIGS. 4, 8, and 9. The visors 30, 40, and 50 may be constructed to include a fabric covering 25 (FIG. 2) suitably attached to the surface of the visors facing the interior of the vehicle to provide a finished appearance. The visors 30 and 50, as seen in FIGS. 2-8, may optionally include a lateral extension 37 from one side to fill any gap of the visor coverage between the vehicle's A-pillar 14 and header rail 18. Visors 30 and 50 may include an illuminated vanity mirror assembly 27 on a side facing the interior of the vehicle, as seen in FIGS. 2 and 4-6.

The mounting brackets 110 for the visor system 60 are secured to the header assembly, as illustrated in FIG. 1, and support torque clips 112, which include bifurcated fingers which engage flats on opposite sides of the pivot pins 70, when installed. The torque clips 112 hold the pivot pins 70 with a force sufficient to hold the relatively lightweight molded visors 30, 40, and 50 in a desired fixed position.

Either or both of the visors 30 and 50 of the visor system 60 may include the auxiliary glare shield 100, which is pivotally mounted to the lower end of the respective visor by pivot rod 102 extending into apertures 85 at the lower end of end caps 80 (FIG. 11). The glare shield 100 may be of the construction and mounted to visors 30 and 50 in a manner such as taught in U.S. Publication No. 2013/0001977 published Jan. 3, 2013, entitled ROTATABLE GLARE SHIELD FOR A VISOR, the disclosure of which is incorporated herein by reference. The glare shield 100 may be made of any suitable material including opaque, transparent, tinted, translucent, polarized, or phototropic panels, as desired, for additional sun-screening protection.

Thus, with the visor system of the present invention, a relatively inexpensive, lightweight and durable visor or visors are provided for an open-roof vehicle and one which uniquely pivots from a front windshield position rearwardly for use with or without the roof in place on the vehicle.

It will become apparent to those skilled in the art that various modifications to the preferred embodiment of the invention as described herein can be made without departing from the spirit or scope of the invention as defined by the appended claims.

The invention claimed is:

1. A visor for an open-roofed vehicle having a windshield and a header rail along the top of the windshield, said visor comprising:
a visor having a pair of curved end members;
an extruded curved panel extending between said end members; and
a pivot mount for mounting said end members to a vehicle for movement in a direction away from a vehicle windshield from a stored position to a lowered sun-blocking position.

2. The visor as defined in claim 1 wherein said curved end members and said extruded curved panel conform in shape to the header rail of the vehicle.

3. The visor as defined in claim 1 wherein said panel and said end members are molded of a polymeric material.

4. The visor as defined in claim 3 wherein said pivot mount includes a torque fitting.

5. The visor as defined in claim 1 and further including an auxiliary glare shield pivotally mounted to said end members, such that it can be rotated from a stored position adjacent and substantially coplanar with said panel to a use position extending away from said panel for providing supplemental sun screening.

6. The visor as defined in claim 5 wherein said auxiliary glare shield is mounted to said panel on a side facing the vehicle windshield.

7. The visor as defined in claim 6 wherein said auxiliary glare shield comprises a panel chosen from the group consisting of an opaque, micro-louver, transparent, tinted, translucent, polarized, and phototropic material.

8. The visor as defined in claim 1 wherein said extruded panel includes a plurality of parallel spaced reinforcing ribs.

9. The vehicle visor as defined in claim 1 and further including a cover of fabric attached to a surface of said curved panel facing the interior of the vehicle.

10. The visor as defined in claim 1 wherein said end members integrally include an insert-molded pivot rod.

11. A vehicle visor comprising:
a curved visor body for conforming to a front header rail of a vehicle, wherein said visor body is an extruded rectangular panel curved in a direction orthogonal to the rectangular shape for conforming to a front header rail of a vehicle;
a pair of end members coupled to said panel at opposite ends; and
a pivot mount for mounting said visor to a vehicle for movement in a direction away from a vehicle windshield from a stored position to a lowered use position.

12. The visor as defined in claim 11 and further including at least one torque clip for mounting to the vehicle and engaging at least one end of said pivot mounts to hold said visor in a position selected by the operator when rotated from a stored position.

13. The visor as defined in claim 11 wherein said panel is extruded of a polymeric material.

14. The visor as defined in claim 13 wherein said extruded panel includes a curved upper section and a substantially straight lower section.

15. The visor as defined in claim 11 and further including an auxiliary glare shield pivotally mounted to a lower edge of said extruded panel on a side of said visor such that it can be rotated from a stored position adjacent and substantially coplanar with a lower section of said panel to a use position extending away from said visor for providing supplemental sun screening.

16. The visor as defined in claim 15 wherein said auxiliary glare shield is mounted to said visor facing the vehicle windshield.

17. The visor as defined in claim 16 wherein said glare shield is coplanar with said lower section of said panel when in a stored position.

18. The visor as defined in claim 11 wherein said extruded panel includes a plurality of parallel spaced reinforcing ribs.

19. The visor as defined in claim 11 wherein a surface of said panel facing the interior of the vehicle includes a fabric cover.

20. A visor system for a vehicle, said system comprising:
first, second, and third visors wherein each visor is made of an extended panel with parallel, spaced-apart reinforcing ribs and end caps at each end of said panel;
pivot control rods intercoupling said visors, such that they can be independently moved; and
torque fittings for mounting said pivot control rods to a vehicle such that each visor can be held in a predetermined operator adjusted position.
